(19) United States
(12) Patent Application Publication
(10) Pub. No.: US 2015/0199743 A1
(43) Pub. Date: Jul. 16, 2015

(54) CONTENT-BASED TRADING RECOMMENDATIONS

(71) Applicant: Cox Digital Exchange, LLC, Atlanta, GA (US)

(72) Inventors: Stephane Pinel, Atlanta, GA (US); Paul David Sims, Alpharetta, GA (US); Stanley Cooper Green, Atlanta, GA (US); Gregory Claud Easterly, Atlanta, GA (US)

(21) Appl. No.: 14/594,510

(22) Filed: Jan. 12, 2015

Related U.S. Application Data
(60) Provisional application No. 61/926,237, filed on Jan. 10, 2014.

(51) Int. Cl. G06Q 30/06; G06Q 30/08

(52) U.S. Cl. CPC G06Q 30/0631; G06Q 30/08

(57) ABSTRACT

Embodiments of the disclosure provide content-based recommendations for organization-to-organization trading. In certain embodiments, a flexible and scalable content-based hybrid recommendation platform can permit generation of a complementary set of dual recommendations for products and seller networks from a buying and selling perspective.

### CROSS-REFERENCE TO RELATED APPLICATION

This application relates to and claims priority from U.S. Provisional Application No. 61/926,237, filed Jan. 10, 2014, which is hereby incorporated herein by reference in its entirety.

### BACKGROUND

Managing or otherwise processing the vast amount of information available in electronic trading of products can be difficult. In conventional web-based trading platforms, such difficulty to lead to poor engagement and churn of end-users.

### BRIEF DESCRIPTION OF THE DRAWINGS

The accompanying drawings are an integral part of the disclosure and are incorporated into the subject specification. The drawings illustrate example embodiments of the disclosure and, in conjunction with the present description and claims, serve to explain, at least in part, various principles, features, or aspects of the disclosure. Certain embodiments of the disclosure are described more fully below with reference to the accompanying drawings. However, various aspects of the disclosure can be implemented in many different forms and should not be construed as being limited to the implementations set forth herein. Like numbers refer to like elements throughout.

FIG. 1 presents an example of an operational environment in accordance with one or more embodiments of the disclosure.

FIG. 2 presents an example of a joined data table for logistic multi-variable regression analysis in accordance with one or more aspects of the disclosure.

FIG. 3A, FIG. 3B, and FIG. 3C illustrate information associated with the implementation of evaluation of the performance of a specific product category in a specific market in accordance with one or more aspects of the disclosure.

FIG. 4 presents an example of another operational environment in accordance with one or more embodiments of the disclosure.

FIGS. 5-6 present examples of user interfaces in accordance with one or more embodiments of the disclosure.

FIG. 7 presents a block diagram of an example computational environment that can implement various aspects of the present disclosure.

FIGS. 8-9 present examples of apparatuses in accordance with one or more embodiments of the disclosure.

FIGS. 10-11 present examples of methods in accordance with one or more embodiments of the disclosure.

### DETAILED DESCRIPTION

The present disclosure recognizes and addresses, in at least certain aspects, the issue of management of the vast amount of information available in web-based trading of products. Adequate management of such information can improve the usually poor user experience in web-based trading of products that can arise from exposure to the vast amount of information associated with such trading The disclosure provides, in certain embodiments, platforms, systems, devices, techniques, and computer-program products for content-based recommendations for trading of products. As an example, products in the present disclosure can include vehicles, computer products, firearms, articles of clothing, jewelry, consumer electronics, yard appliances, construction machines and equipment, aircraft, boats, office equipment, furniture, manufacturing equipment, packaging equipment, kitchen equipment, appliances, combinations of the foregoing, related products and components, or the like. It should be appreciated that while the disclosure is illustrated via embodiments, features, and the like, in which the products are or include vehicles, the features of the disclosure can be applied to other products as exemplified herein. The content-based recommendations in accordance with aspects of this disclosure can be utilized in organization-to-organization trading (such as trading amongst car dealerships) and can permit an organization (e.g., a dealer) to buy and/or sell products by matching the organization to suitable inventory and dealers. In certain implementations, embodiments of the disclosure can provide a flexible and scalable content-based hybrid recommendation platform that can generate a complementary set of dual recommendations for vehicles and dealership networks from a buying and selling perspective. More specifically, such a set is complementary in that the group of recommendations that is generated for vehicles (or other type of products) complements the group of recommendations that is generated for dealer networks (or other type of networks of product traders), and vice versa. Accordingly, a vehicle recommendation and a dealer network recommendation that are generated complement each other. In addition, the generated recommendations are dual with respect to buying and selling in that a group of recommendations that is generated includes two subgroups of recommendations: A subgroup of buying recommendations and a subgroup of selling recommendations. One or more of the generated recommendations can permit management of business operations of an organization, e.g., a dealer or the administrator of the content-based recommendation platform.

As described in greater detail below, a content-based recommendation platform and/or techniques in accordance with the present disclosure can uniquely leverage or otherwise utilize a business goal optimization module and several hybridization techniques to address multiple business operations (which also may be referred to business use cases or operational scenarios). For instance, offer acceptance rate on a portal or trading interface (e.g., a website configured by the administrator of such a platform). In certain embodiments, the content-based recommendation platform can include a profile learning module, a business goal optimization module, and a recommendation module. The profile learning module can compose or otherwise determine buying and/or selling profiles of an organization (e.g., a dealer) or an agent thereof. At least a portion of such profiles can be categorized as implicit or explicit. The business goal optimization module can determine (e.g., extract) a vehicle and/or dealership ranking model(s) that can be utilized or otherwise leveraged to optimize a business goal of the administrator of the content-based recommendation platform. Such model(s) may be referred to as rating model(s) and can include a model utilized or otherwise leveraged to produce a satisfactory (e.g., maximal or nearly-maximal) offer acceptance rate on a web-based trading platform for a product, such as a vehicle. It should be appreciated that in certain embodiments, the profile described herein can include various attributes representative or otherwise indicative of trading or otherwise commercial behavior of an organization. For instance, the profile (which may be referred to as a organization profile) can include or otherwise convey which vehicles a dealer turns, dealer's inventory (e.g., vehicles in the dealer's lot and/or vehicle of the dealer in stock), the inventory the dealer should stock, the vehicles that are moving into the area in which the dealer is located, the dealer's buying preferences (e.g., vehicles, counter parties, price range, condition, etc.), the dealer's selling patterns (vehicles, counter party types and identities, price range and flexibility, condition, etc.), recent activity, historical activity, peer and market activity, arbitrage opportunities and openness to arbitrage (e.g., geographic opportunities). Such rich behavior information for an organization can be leveraged herein to provide product recommendations for purchase of a product (e.g., a vehicle) for purchase for a trading organization, and to identify one or more organizations from which the recommended product can be purchased. In addition, in at least certain aspects, at least a portion of the trading behavior information can provide recommendations of a product for sale for the trading organization, wherein such a product for sale is included in a product inventory of the trading organization. Moreover, the recommendation of the product for sale can convey a network of one or more second trading organizations configured to purchase the second product.

The content-based recommendation platform and recommendation techniques of the disclosure can permit increasing the visibility of products (e.g., vehicles) that are simultaneously relevant to the user of a trading platform that leverages the content-based recommendation platform and, for example, maximize the offer acceptance rate in the event of an offer. As it can be appreciated, the relevance and ranking of a recommended product (e.g., a vehicle) can be business-use-case dependent. The disclosed content-based recommendation platform and associated recommendation techniques can support or otherwise permit implementation of multiple evaluation/rating procedures that contemplate specific business operation scenarios or objectives. In addition, such a content-based recommendation platform and techniques can provide sets of dual, complementary recommendations for products (e.g., vehicles) and organization (e.g., dealership) networks from a buying and selling perspective. It should be appreciated that the content-based recommendation platform and recommendation techniques in accordance with aspects of this disclosure can permit leveraging or otherwise utilizing a large volume of transaction information to the benefit of buyers and sellers, while providing a superior user experience. Therefore, in one aspect, user retention can be increased in a trading platform or an organization that operates or otherwise administers the content-based recommendation platform.

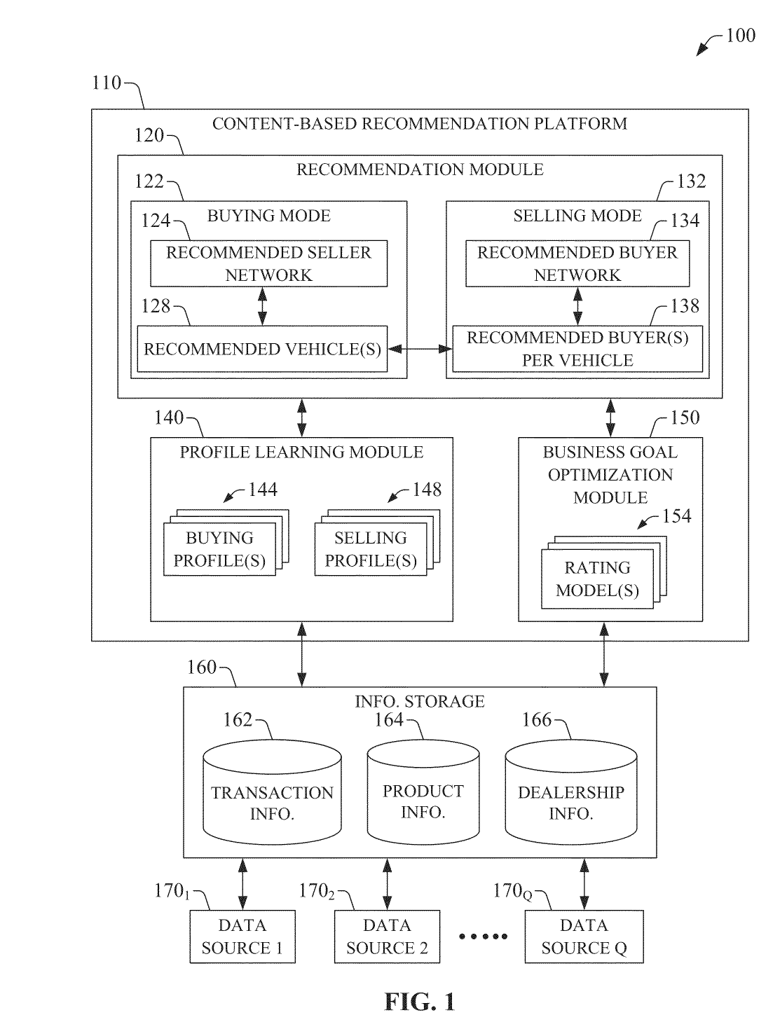

FIG. 1 illustrates an example embodiment 100 of a content-based recommendation platform 110 in accordance with at least some aspects of the disclosure. While arrows in the content-based recommendation platform 110 are illustrated as unidirectional, it is noted that scenarios in which information (e.g., data, metadata, and/or signaling) is communicated (e.g., sent, received, and/or exchanged) bi-directionally also are contemplated in the present disclosure. More specifically, yet not exclusively, the one-directional arrows can be represented or depicted as bi-directional arrows in certain implementations. As illustrated, the content-based recommendation platform 110 can have access to transaction information and/or organization (e.g., a car dealership) information from a plurality of information sources, which are represented as data source 1 170₁, data source 2 170₂, . . . , and data source Q 170_{Q}, where Q is a natural number greater than unity. In certain embodiments, the organization can be embodied in or can include a car dealership, and the information can include data, metadata, and/or signaling. In addition or in other embodiments, the plurality of information sources may be referred to as a niche ecosystem, such as an automotive ecosystem of information sources. For instance, such information sources can include product information and/or transaction information from an inventory exchange system, a retail listings company, wholesale auctions, a combination thereof, or the like. In certain implementations, at least a portion of such information can be representative or otherwise indicative of millions of products (e.g., millions of vehicles). The product information and/or the transaction information that can be accessed by the content-based recommendation platform 110 can be retained in one or more memory devices collectively referred to as information storage 160. The information retained in the information storage 160 can include transaction information 162, including (i) inventory and historical transaction data (e.g., vehicle identification number (VIN) movements in the case of the products being or including vehicles) extracted from one or more trading platforms; and (ii) auction historical transaction information (e.g., data and/or metadata) extracted from a product auction platform (e.g., a web-based platform, a wholesale auction platform, or both). The information storage 160 also can include product information 164, including activity information obtained from a trading platform (e.g., a trading website and associated infrastructure), where in certain embodiments, such information can include offer data; “listed for sale” data (which can include data provided by a seller or a third party on behalf of the seller, search result page filters, product detail webpages (e.g. vehicle detail pages); activity information obtained from a mobile interface (e.g., mobile application and/or mobile web) of the trading platform; product information (e.g., vehicle scan data); and/or information (e.g., data, metadata, and/or instructions) available in a VIN decoding database or repository, and/or received at the information storage 160 via a module (in a mobile device, for example) for scanning a VIN. In addition, the information storage 160 can include dealership information 166, which can include all or some of the information about an organization (e.g., car dealerships) that may be collected or otherwise available in a customer relationship management (CRM) system.

In certain embodiments of the content-based recommendation platform 110, the profile learning module can aggregate and/or generalize all or some of the information (e.g., data, metadata, and/or signaling) representative of organization preferences (e.g., user/dealership preferences) in order to construct organization profiles (e.g., user profiles, such as dealership profiles), which can include implicit buying and/or selling profiles, and/or explicit buying and/or selling organization profiles (e.g., user profiles, such as dealership profiles). It should be appreciated that the transaction information that is accessed or otherwise acquired can embody or otherwise include the content that permits generating recommendations of product for purchase or sale in accordance with aspects described herein.

In certain embodiments, the implicit buying and selling profiles can include (but are not limited to including) the following information: (A) Favorites “Year-Make-Model,” traded directly with another car dealership (e.g., traded outside of a vehicle trading platform for the trading of items between dealers); traded at wholesale auction and/or wholesale online timed sale (e.g., Online Vehicle Exchange (OVE), and/or other web-based or brick-and-mortar market places (such as auctions); searched or viewed on inventory trading/direct sales website (buying only, for example); made offers on inventory trading/direct sales website (buying only, for example); and/or placed bids on inventory trading/direct sales website (buying only, for example). (B) Favorites “price-range/odometer/car category (optional, for example)”, traded directly (e.g., outside of a vehicle trading platform) with another car dealership; traded at Wholesale Auction and/or Wholesale Online Timed Sale (such as OVE); searched or viewed on inventory trading/direct sales website (buying only, for example); made offers on inventory trading/direct sales website (applicable to buying profile, for example); and/or placed bids on inventory trading/direct sales website (applicable to buying profile, for example). (C) Fastest inventory turn Year-Make-Model. (D) Fastest inventory turn price-range/odometer/car category (optional, for example). (E) Slowest inventory turn Year-Make-Model. (F) Slowest inventory turn price-range/odometer/car category (optional, for example).

The explicit buying and selling profiles can include (but are not limited to including) the following information: (A) Saved searches: any filtering vectors saved by the user/dealership on inventory trading/direct sales website using available search criteria, such as year, make, model, trim, odometer, retail price range, distance, location, in personal network, inventory trading/direct sales website members, marked “ready to move”, marked in an event sales, body type, engine type, fuel type, transmission, equipment (standard, optional, aftermarket), dealer type, door, free form search text, . . . ). It should be appreciated that, in certain examples, saved searches may be applicable to buying profiles only. (B) User ratings: simple binary ratings and/or symbolic rating mapped to a numeric scale, made by the user (buyer) on inventory trading/direct sales website. (direct feedback, for example). (C) Vehicles marked as available for sale under specific trade condition(s) (e.g., “ready to move” vehicles). It should be appreciated that, in certain examples, information indicative or otherwise representative of marking vehicles in such a manner may be a feature applicable to selling profiles only. (D) Vehicles placed in inventory trading and/or direct sales website for a predetermined sale event (e.g., sales at specific time of the year, month, week, or day. It should be appreciated that, in certain examples, information indicative or otherwise representative of placement of vehicles in such a manner may be a feature applicable to selling profiles only.

As illustrated and described herein, the content-based recommendation platform 110 can include a recommendation module 120 that can support or otherwise utilize multiples profiles per organization (e.g., a user, such as a car dealership) corresponding to different operational scenarios (also referred to as business use cases). In certain implementations, the recommendation module 120 can utilize or otherwise leverage hybridization techniques to combine organization profiles (e.g., buying profiles, selling profiles, or a combination thereof) and generate one or multiple recommendation types (such as different recommendations for different scenarios, user stated preferences, and/or goals).

In certain embodiments, at least one profile (e.g., one profile, two profiles, more than two profiles, or each profile) can contain a set of search vectors weighted using the number of occurrence in the information (e.g., data and/or metadata) that is accessed by the content-based recommendation platform 110. The aggregation can be performed on any time period, such as the last 30, 45, 60, or 90 days of information (e.g., data and/or metadata), depending on the profiles considered. In some cases (e.g., Favorites “Year-Make-Model” traded directly with another dealership), forecasted data of these profiles can be used to capture seasonality effects and longer periods are then considered based upon data availability. The maximum number of vectors per profile can be limited (typically to a number from 10 to 20, for example) based on the processing hardware and/or other types of computing resources available.

In addition or in the alternative, organization profiles (e.g., user profiles, such as car dealership profiles) in accordance with the disclosure can be augmented, thus recommending additional profile vectors in order to overcome potential over-specialization effects and to promote or insure the diversity (e.g., novelty and serendipity) of the trading recommendations that are generated. In certain embodiments, the organization profiles can be augmented by using collaborative filtering techniques (e.g., finding the “k-nearest neighbors” organizations (e.g., users, such as car dealerships) and/or by generating new profiles via user-user and/or item-item filtering. In one example, the additional profile vectors generated using collaborative filtering can be specifically identified, so they can be processed accordingly by the recommendation module 120 during a hybridization phase of the recommendation processes in accordance with this disclosure.

As illustrated and described herein, the content-based recommendation platform 110 includes a business goal optimization module 150 that can extract a product (e.g., a vehicle and organization ranking model(s) (e.g., dealership ranking model(s)) that can be leveraged or otherwise utilized for optimizing or otherwise rendering satisfactory one or more business goals of the organization that administers (e.g., develops, deploys, leases, owns, or the like) the content-based recommendation platform 110. Multiple models are assigned to each User (e.g., car dealership) individually, aiming at optimizing or otherwise satisfactorily achieving multiple business goals and enabling multiple and personalized recommendations for a specific profile vector.

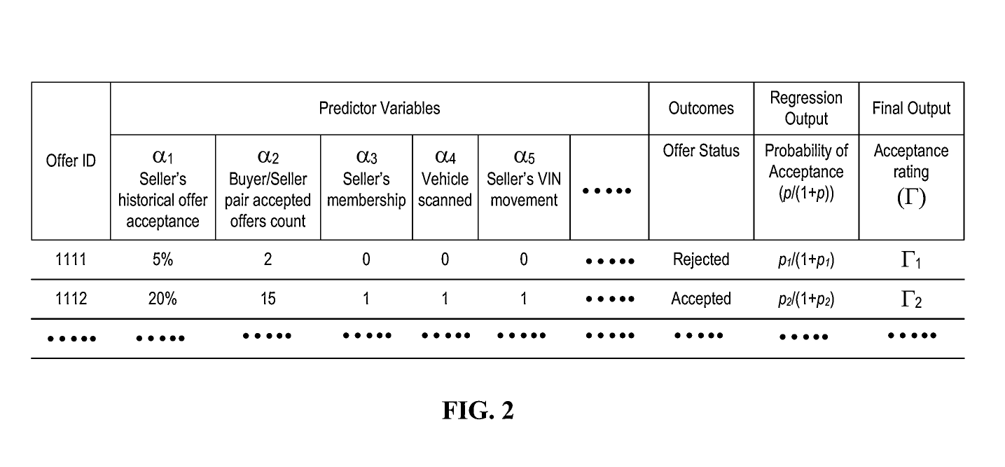

In certain embodiments, the primary business goal of the content-based recommendation platform 110, or an organization that operates or otherwise administers such a platform, can be to maximize the offer acceptance rate on trading platform (e.g., a website) of such the organization. As an illustration, the inventory trading/direct sales website offers data (offer accepted/rejected/pending, offer amount, . . . ) can be first joined with some or all of the data available about the products (e.g., vehicles), the seller organizations (e.g., seller dealerships), and/or the buyer organizations (e.g., the buyer dealerships). Such joined data can be processed using machine-learning techniques to extract the relevant factors driving the acceptance rate. The machine-learning techniques can include, for example, multi-layer neural networks and logistic multi-variable/multinomial regression analysis, naïve Bayes classifier, support vector machine (SVM), perceptron, linear discriminant analysis, quadratic classifier, and so forth. More specifically, yet not exclusively, logistic regression analysis can be implemented via the machine-learning techniques. It should be appreciated that, in certain embodiments, the specific machine-learning techniques relied upon in the present disclosure can be retained in the one or more rating model(s) 154. Without intending to be bound by theory, simulation, or modeling, the machine-learning techniques can be applied as described in DeMaris, “A Tutorial in Logistic Regression,” Journal of Marriage and the Family 57 (1995): 956-968. An example of a joined data table used for logistic multi-variable regression analysis in accordance with this disclosure is shown in FIG. 2, where the parameters α₁, α₂, α₃, α₃, α₄, α₅, and so forth, are real numbers representing relevant parameters (e.g., attributes of the product (such as a vehicle), seller, buyer and the combination of buyer and seller).

An example of a generic expression for the offer acceptance rating (F, which is a real number) can be formulated as:

$$Γ = \frac{p}{1 + p} + f , \qquad Eq . ( 1 )$$

Where p/(1+p) represents a probability of acceptance, p is a real number, and p=exp (ε+Σₙβₙ*αₙ), ƒ is a real number and ƒ=Σₘδₘ*θₘ. It should be appreciated that other formal expressions for the offer acceptance rating F can be defined or otherwise contemplated. The expression in Eq. (1) and/or other expressions for an offer acceptance rating can be included in one or more rating models 154. In Eq. (1), the coefficient ε is the intercept point of the multivariable regression model and some optional offsets (e.g., offsets that permit accounting for pricing assumptions); {αₙ} can embody or can include a list of N relevant parameters (e.g., attributes of the product (such as a vehicle), seller, buyer and the combination of buyer and seller); {β} is a list of N weight coefficients determined by the multi-variable regression analysis. Here, n is an index adopting natural number values and N is a natural number. In addition, ƒ is a custom function, which can be referred to as a “boost” function and, as described herein, is defined using a list of M parameters {δₘ} and its respective weight coefficient list {θₘ} where m is an index adopting natural number values and M is a natural number. It should be appreciated that, in certain embodiments, the parameters {δₘ} and the weight coefficients {θₘ} can be utilized or otherwise leverage to model additional or other business rules associated with trading, and can be selected or otherwise determined without the reliance on the machine-learning techniques. Machine-learning techniques as described herein can be are utilized to identify or otherwise determine a group of relevant parameters {αₙ}, which may be referred to as the “predictors,” and generate an estimated value of the parameters {βₙ} which are the respective weights for each of the group of relevant parameters {αₙ}. More specifically, yet not exclusively, the predictors and their respective beta weights of the logistic regression analysis can be determined concurrently using a combination of “maximum likelihood” estimation and an iterative process (for example using Newton's method), where a pseudo-R² technique can be utilized to assess the quality of fit of the resulting model. The parameters {αₙ} and {βₙ} so determined permit determining a value of p as defined above. The value of p in conjunction with a computation of the boost function ƒ then permit determining a value of Gamma according to Eq. (1). In certain embodiments, N=12 and M=2, and examples of the relevant parameters {αₙ} (e.g., attributes) and {δₘ} can include one or more of the following, individually or in any combination:
α₁: Seller's inventory trading and/or direct sales (e.g., DealerMatch) historical offer acceptance rate;
α₂: Buyer/seller pair inventory trading and/or direct sales (e.g., DealerMatch) accepted offers count;
α₃: Seller's inventory trading and/or direct sales website membership—for example, this attribute can be set to 0 by default and set to 1 if the seller is a member of such websites;
α₄: Vehicle Scanned—for example, this attribute can be set to 0 by default and set to 1 if the vehicle has been scanned on inventory trading/direct sales website's mobile interface (e.g., mobile application and/or mobile web);
α₅: Seller's VIN movement index—for example, this attribute can be set to 0 by default and set to 1 if the seller dealership exhibits selling overall more cars to others dealerships in business-to-business transactions than he buys from others dealerships;
α₆: Seller belongs to a buyer's trading network—for example, this attribute can be set to 0 by default and set to 1 if the seller belongs to the buyer's trading network based on VIN movement analysis;
α₇: Seller belongs to Buyer's inventory trading and/or direct sales website (e.g., DealerMatch) network—for example, this attribute can be set to 0 by default and set to 1 if the seller belong to the buyer's inventory trading and/or direct sales website network);
α₈: Geolocation index (e.g., domain specific buyer/seller geolocation effect);
α₉: Geographical distance between buyer and seller;
α₁₀: Vehicle's attributes index, which can account for inventory aging and turn, financing, and so forth;
α₁₁: Seller's business attributes index, which can account for financial, transaction volume, and so forth; and
α₁₂: Buyer's business attributes index, which can account for financial, transaction volume, and so forth.

In addition, regarding the boost function ƒ, the list {δₙ} (for N=2) can include two elements:
δ₁: Vehicle marked or otherwise characterized as “listed for sale” under specific condition(s), and
δ₂: Vehicle marked as included in a predetermined sale occurring at a specific time (e.g., certain day) in an inventory trading and/or direct sales website or platform; for example, vehicle can be marked as “listed for sale” on behalf of the seller by a third party.

It should be appreciated that in certain implementations, other relevant parameters {αₙ} (e.g., attributes) can be leveraged or otherwise utilized to represent formally the offer acceptance rate.

In certain embodiments, the content-based recommendation platform 110, or an organization that operates or otherwise administers such a platform, can evaluate the commercial performance of a specific product category versus a market. In addition or in other embodiments, the content-based recommendation platform 110 can directly provide market insight to its customers. As an illustration, the performance versus the market of product/organizations (e.g., vehicles/dealerships) categories (e.g. Vehicle make—Dealer type (franchise, independent, etc. . . . ) can be evaluated as a function of relevant parameters {αₙ} (e.g., attributes). In order to compute the performance of the product category versus a market, in one example, machine-learning techniques can be utilized to extract the parameters {αₙ}, and a performance function g that depends on one or the extracted attributes can be computed. The value of the function g can be indicative or otherwise representative of the performance. In certain implementations, the function g can be the same as F. In one example, for the case N=9, the attributes {αₙ} that can be utilized to compute g can include one or more of the following, individually or in any combination:
α₁: Market location;
α₂: Seller's type and business attributes;
α₃: Vehicle's attributes (year, make, model trim, average odometer for the given vehicle make—Dealer type category);
α₅: Total Vehicle in stock;
α₆: Vehicle in stock per dealer;
α₇: Market share (e.g., organization (e.g., car dealership) share of total stocked at retail in market);

α₈: Total Stocked at auction; and
α₉: Average turn time.

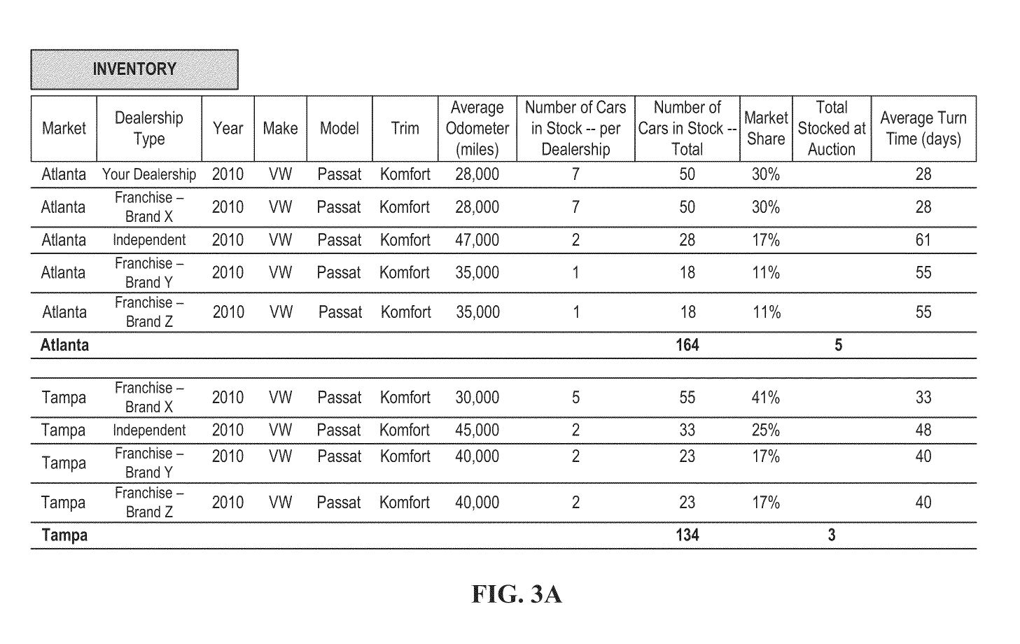

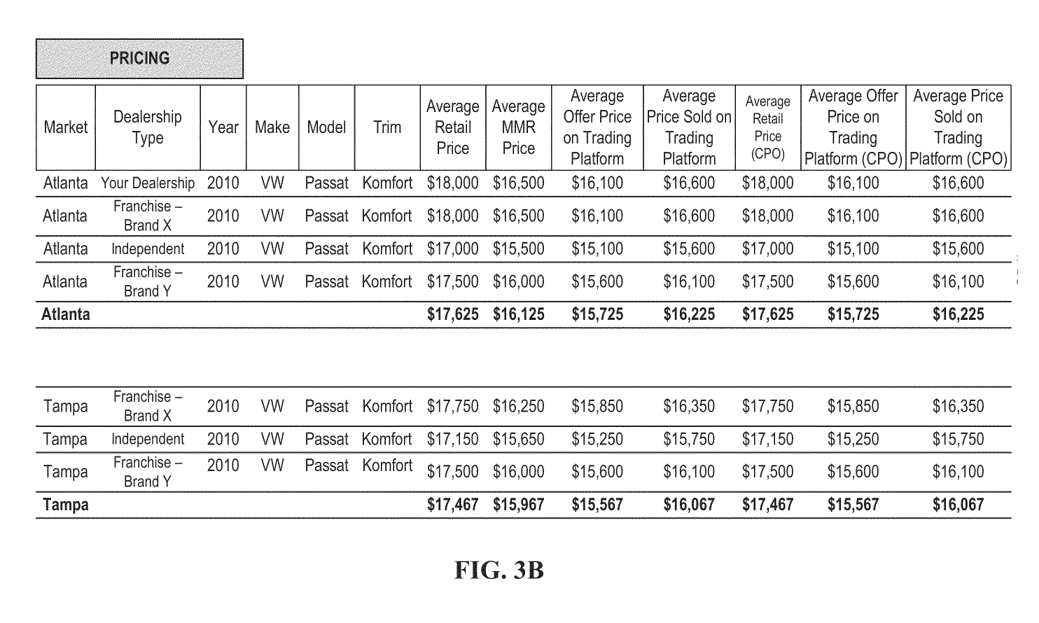

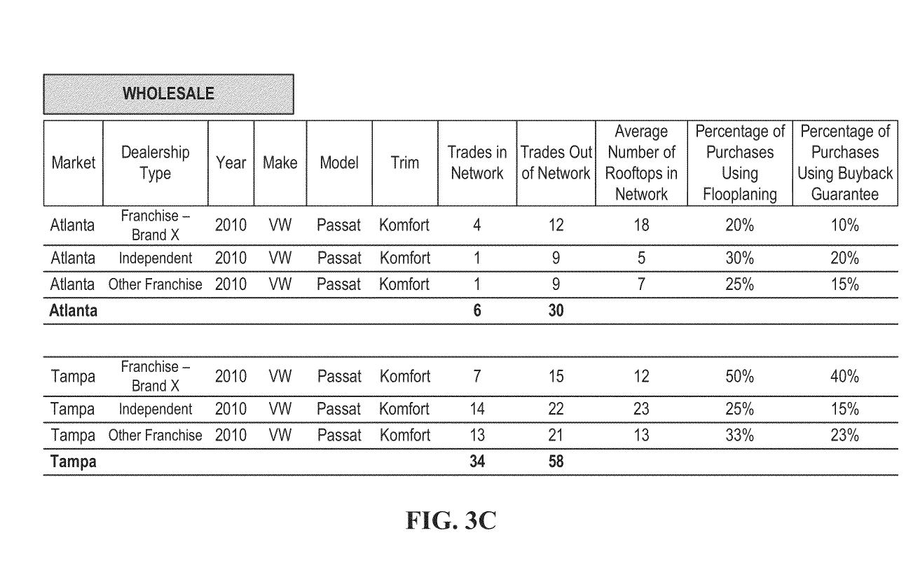

FIGS. 3A, 3B, and 3C illustrate information associated with the implementation of evaluation of the performance of a specific product category in a specific market in accordance with one or more aspects. More specifically, FIG. 3A, illustrates information related to inventory in two different markets (represented by Atlanta, Ga., and Tampa, Fla.). The market share that is shown corresponds to a dealership's share of total stocked at retail in a market (e.g., Atlanta). For a market, entries in boldface font indicate total values for their respective columns. FIG. 3B illustrates information related to pricing in two different markets (represented by Atlanta, Ga., and Tampa, Fla.). In one example, the trading platform (e.g., DealerMatch) can be the platform that operates or otherwise administer the content-based recommendation platform 110. The acronyms MMR and CPO represent “Manheim market report” and “certified pre-owned,” respectively. For a market, entries in boldface font indicate total values for their respective columns. FIG. 3C illustrates information related to wholesale performance in two different markets (represented by Atlanta, Ga., and Tampa, Fla.). In FIG. 3C, trades in network refer to transacted vehicles within a network of car dealerships associated with the content-based recommendation platform 110. Similarly, trades out of network refer to transacted vehicles outside such a network of car dealerships.

As illustrated and described herein, the content-based recommendation platform 110 can include a recommendation module 120 that can operate on a buying recommendation mode (e.g., buying mode 122) and selling recommendation mode (e.g., selling mode 132), and can leverage feature augmentation and meta-level hybridization techniques to generate a complementary set of vehicles and partner dealerships recommendations. In the buying mode 122 in accordance with this disclosure, in certain implementations, the recommendation module 120 can utilize or otherwise leverage as inputs the profile and model respectively generated by the profile learning module and business goal optimizer module, and can generate a ranked list of recommended products (e.g., vehicles) for each organization (e.g., a car dealership). Such a list of recommended products (e.g., recommended vehicles) can be utilized (e.g., hybridization) to generate a ranked list of recommended seller partner organizations (e.g., car dealerships) for each buying organization (e.g., a car dealership). In the selling mode 132 in accordance with this disclosure, in certain implementations, the recommendation module 120 can utilize or otherwise leverage at least a portion of the ranked list of recommended products (e.g., recommended vehicle(s) 128) and partners for each buyer dealership generated in buying mode to extract (e.g., hybridization) a ranked list of potential buyer partner dealerships for each vehicle of each seller (e.g., the selling dealership).

Example Functionality of the Content-Based Recommendation Platform 110 in Buying Mode.

Considering a buyer user (e.g., a car dealership), the recommendation module 120 can query the information storage 160 for all or at least some available vehicles that match one or more search criteria for a buying profile vector. In the present disclosure, a “profile vector” (either a buying profile vector or selling profile vector) can be embodied in or can include is a list of attributes associated with a user (either a buyer or a seller), each of the attributes representing a component of the profile vector. The attributes in the profile vector can be indicative or otherwise representative of the user's buying and/or selling behavior. For a user having a single profile vector, the “user profile” (e.g., buying profile or selling profile) can be represented by the single profile vector. In addition, for a user (buyer or seller) having multiple profile vectors, the user profile can be represented by the aggregation of the multiple profile vectors. For example, a user can have three profile vectors: (1) (2010, Honda, Accord), (2) (2011, Honda, Accord), and (3) (2005, Toyota, $8,000 to $9,000) (here, the third component is indicative of a typical (e.g., historical or preferred) price range). Thus, the profile of such a user is the aggregation of profile vectors (1) through (3). With regard to the query, in certain embodiments, the recommendation module 120 can query a database (relational or otherwise) or other data structures available in the information storage 160. The use of normalized data greatly reduces the computing requirements by allowing simple string or numerical matching between the buying profile vector and the vehicle attributes vector during the query. In addition or in the alternative, the matching can be realized by computing the cosine similarity between the two vectors. In certain embodiments, the query can also be performed using commercial full-text search engine (e.g., Solr/Lucene, ElasticSearch, or the like). Thus, in one example, this initial query can result in an unranked list of recommended vehicles.

In certain implementations, offer acceptance rating(s) can be determined or otherwise computed for each vehicle using the rating model(s) described herein in connection with maximizing offer acceptance rates. It should be appreciated that, in certain embodiments, the information (e.g., data and/or metadata) indicative of seller dealerships' selling profiles (e.g., selling profile(s) 148) can be considered during this computation, implicitly matching buyer's buying profiles (e.g., buying profile(s) 144) and seller's selling profiles (e.g., selling profile(s) 148). Such matching can result, in one aspect, in a rated and/or ranked list of recommended vehicles. Typically, this computation can be systematically performed for all or at least some of the “buyer” user (e.g., car dealerships) present in or otherwise accessible to the content-based recommendation platform 110 on a daily basis, according to another period (e.g., hourly, weekly), according to a schedule, and/or other type of timing protocol. Performing such a computation, either periodically or according to any schedule or timing protocol, can result in a rated and/or ranked list of recommended vehicles (e.g., recommended vehicle(s) 128) that can be stored or otherwise retained for subsequent hybridization operations in accordance with aspects of this disclosure.

In addition or in other implementations, the recommendation module 120 can utilize or otherwise leverage a rated and/or ranked list of recommended vehicles (e.g., recommended vehicle(s) 128) to generate a list of recommended seller partner dealerships, which can be referred to as “seller network” recommendations. As illustrated in FIG. 1, such a list can be referred to as recommended seller network(s) 124 and can be retained in the content-based recommendation platform 110. In one example, for each “buyer” user (e.g., a car dealership), the list of distinct seller dealerships owning vehicles in the buyer user's rated and/or ranked list of recommended vehicles can be identified or otherwise determined and can be saved as a seller-network recommendations list (e.g., recommended seller network 124). Such a list also can be rated and/or ranked according to a computed average rating of respective vehicles in the rated and/or ranked list of recommended vehicles that each seller dealership owns and that can be relevant to the buyer user. It should be appreciated that in certain additional or alternative implementations, the number of relevant products (e.g., vehicles) and the distribution of product ratings (such as vehicle ratings) also can be retained or otherwise stored for future uses, such as in different seller rating algorithm(s). The number of relevant products can correspond, for example, to the number of products that each seller user owns and that may be relevant to a buyer user. In the present disclosure, buyer user and seller user also are generally referred to as a “buyer” and “seller,” respectively.

As illustrated in FIG. 1 and described herein, in certain embodiments, the content-based recommendation platform 110 can include a recommendation module 120 that can generate a rated and/or ranked list of recommended products (e.g., vehicle recommendations), and/or a rated and/or ranked list of recommended seller partner dealerships (e.g., network recommendations) for one or more (e.g., one, two, more than two, each, all) “buyer” users (e.g., a car dealerships) present or otherwise available in the content-based recommendation platform 110. In addition or in other embodiments, the recommendation module 120 can support or otherwise provide on-demand functionality, such as generating, as described herein, these two lists for a given dealership and an on-demand buying profile vector(s).

Example Functionality of the Content-Based Recommendation Platform 110 in Selling Mode: Inventory Management.

Considering a seller user (e.g., a seller car dealership), the recommendation module is exploiting (e.g., hybridization) the rated and/or ranked list of recommended vehicles generated previously in buying mode. In one example, the recommendation module can determine or otherwise identify some or all the vehicles owned by the seller, which have been recommended to at least one buyer dealership(s), and append to these vehicle data their respective list of buyer dealerships, along with the previously computed vehicle ratings. In one example, these appended data are essentially a rated and/or ranked run list of buyers for each vehicle. The sum of these ratings is computed and stored as a “sellability” rating for each of the vehicles. The distribution of these ratings also can be retained for other uses (e.g., for implementing different sellability rating algorithms). Typically, this computation is systematically performed for all the “seller” user/dealerships in the system on daily basis, resulting in a rated and/or ranked list of recommended “vehicles-to-sell” that is stored for subsequent hybridization operations.

In addition to a rated and/or ranked list of recommended buyer(s) for each product (e.g., each vehicle), such as the recommended buyer(s) per vehicle 138, the buyer network recommendations for a seller user (e.g., seller dealership) can be extracted by aggregating the list of buyer dealerships appended to the list of recommended “vehicles-to-sell” into a list of unique buyers. To that end, in one example, the recommendation module 122, in selling mode, can determine or otherwise extract buyer network recommendations for a seller user by performing the aggregation described herein. In certain embodiments, the average of the previously computed vehicle ratings can be computed and stored as a buyer rating for each of these buyers. Alternatively or in additional embodiments, the rated and/or ranked list of recommended seller partner dealerships (e.g., recommended buyer network 134) generated previously in buying mode can be used to the same effect.

It should be appreciated that, in one aspect, the selling mode 132 as described herein of the recommendation module 120 can utilize or otherwise leverage as information input (which also may be referred to as “inputs”) the information (e.g., data and/or metadata) generated in buying mode 122. Accordingly, in certain implementations, the selling recommendations can be directed essentially to the products (e.g., vehicles) identified in buying mode. It should be appreciated that the latter illustrates the duality and complementarity of the recommendations generated in accordance with aspects of this disclosure. In certain embodiments, the recommendation module 120 can support or otherwise provide additional on-demand functionality generating a rated and/or ranked run list of buyer for an arbitrary product (e.g., arbitrary vehicle). In such a scenario, buying profile information (e.g., data and/or metadata, represented as buying profile(s) 144) generated by the profile learning module 140 of the content-based recommendation platform 110 can be directly queried to identify a list of unique buyers having buying profile vectors matching the arbitrary product. The sum of the weight of each of these vectors can be computed and utilized or otherwise leveraged as “buyer” rating for each of the buyers in the list of unique buyers.

It can be appreciated that, in certain embodiments, a generalized inventory management system encompassing all the vehicles in the dealership inventory also can be implemented. The generalized inventory management system can track (continuously or at certain frequency) the inventory of a seller (e.g., a car dealership), and can determine recommendations, based on the tracked inventory, for potential buyers; locations and/or times (e.g., time of the month) to sale a product (e.g., a vehicle) in the inventory; and/or price at which the product should be sold in order to maximize the financial and/or commercial interests of the seller.

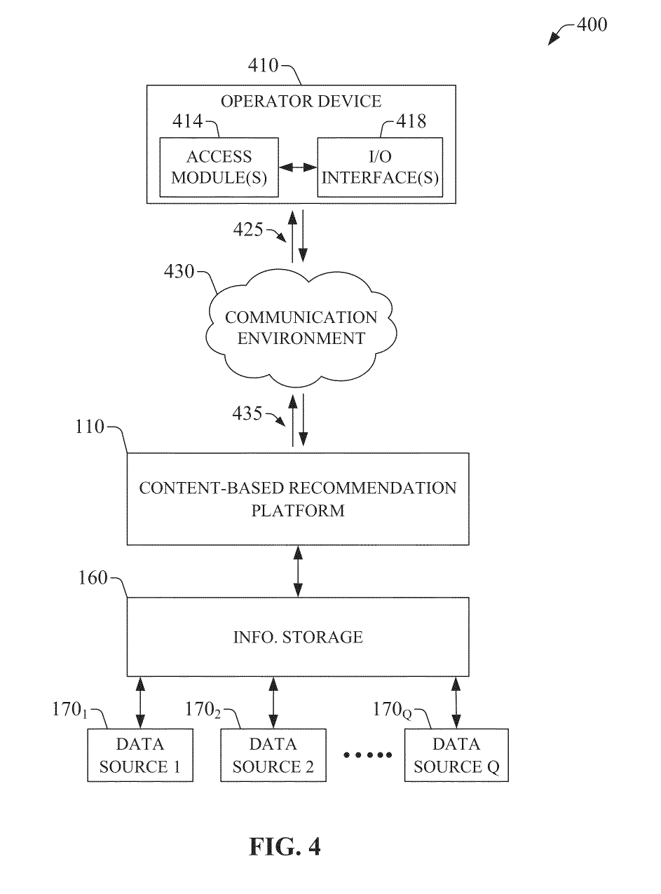

FIG. 4 illustrates an example of an operational environment 400 for consumption or utilization of trading recommendations generated in accordance with one or more embodiments of the disclosure. As illustrated, the operational environment 400 includes an operator device 410, which can be embodied or can include a computing device having certain computing resources (e.g., processor(s), memory devices, interfaces, communication devices, and the like). The operator device 410 can include an access module 414 that can permit exchange of information (e.g., data, metadata, and/or instructions) to the content-based recommendation platform 110. To that end, in one example, the operator device 410 can be functionally coupled (e.g., communicatively coupled) a communication environment 430 via communication links 425. One or more components (e.g., network nodes) of the communication environment 430 can be functionally coupled to the content-based recommendation platform 110 via communication links 435. Therefore, the communication environment 440 can permit the exchange of information between the access module 414 and the content-based recommendation platform 110. In certain embodiments, the communication environment 430 can include network elements (such as base stations, access points, routers or switches, concentrators, servers, and the like) that can form a local area network (LAN), a metropolitan area network (MAN), a wide area network (WAN), a combination thereof, or other types of networks. Each of the communication links 425 and 435 can include wireless links and/or wireline links, and also can include, for example an upstream link (UL) and/or a downstream link (DL).

As illustrated, the operator device 410 can include one or more input/output (I/O) interfaces 418 that can permit receiving and presenting information to an operator (or end-user). In certain embodiments, the I/O interface(s) 418 can include display units, including touch screens, reader devices (such as barcode scanners or NFC devices), haptic devices, network adapters, peripheral interfaces, or the like. One of the access module(s) 414 can receive at least some of the input information received via at least one of the I/O interface(s) 418. Similarly, information received by one or more of the access module(s) 414 from the content-based recommendation platform 110 can supplied to one or more of the I/O interface(s) 418 in order to present at least a portion of the information or a processed (e.g., rendered) version thereof to the operator. More specifically, in certain embodiments, one or more of the access module(s) 414 can permit generating and/or rendering information indicative or otherwise representative of user interfaces for consumption of content-based recommendations in accordance with aspects of this disclosure. In one example, a module of the access module(s) 414 can generate information indicative of selectable or otherwise actionable indicia that can be presented to an operator for providing information or otherwise interacting with the content-based recommendation platform 110. In addition or in other embodiments, such a module can implement the selection or actuation logic associated with the selectable or actionable indicia.

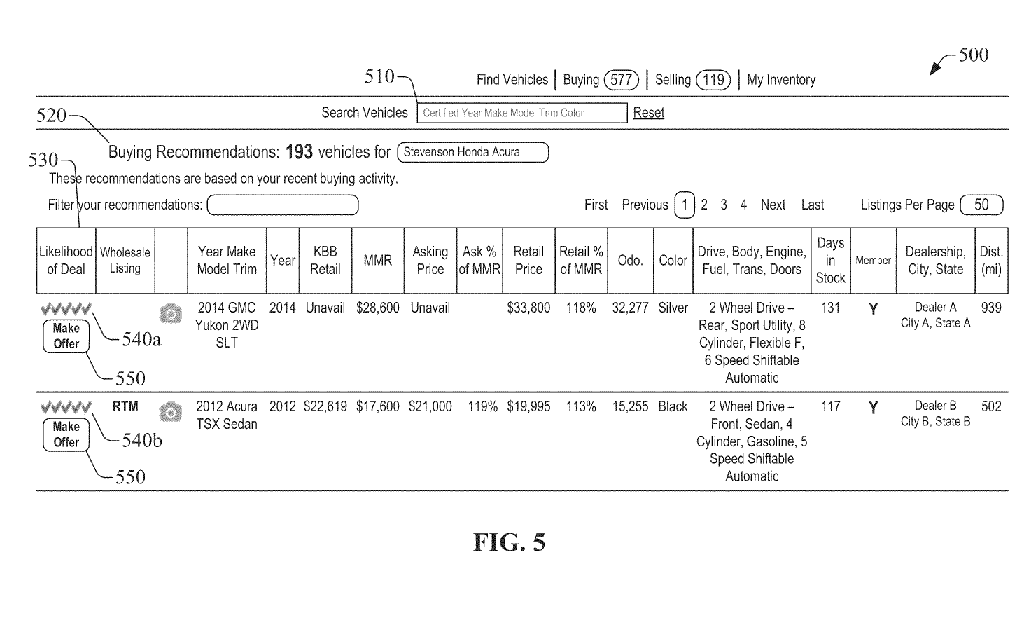

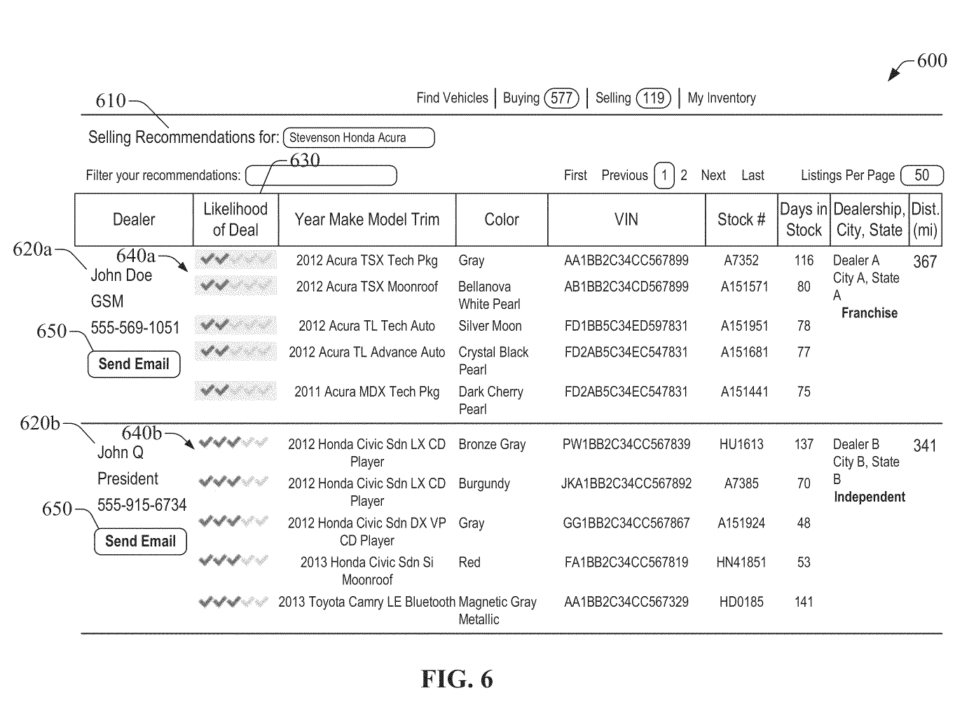

Certain indicia (selectable or otherwise) generated by at least one of the access module(s) 414 can convey a list of recommendation for a buyer and/or a seller. To that end, at least one of the I/O interface(s) 418 can present the indicia within a user interface. As an illustration, FIGS. 5 and 6 present example UIs 500 and 600 for buying recommendations and selling recommendations, respectively. As illustrated in both UIs, the recommendations can be presented in tabulated format, with each recommendation having an offer acceptance rating (e.g., a specific F) calculated in accordance with aspects of the disclosure and other parameters or information characterizing the recommendation. In the example UI 500, the offer acceptance rating is represented with indicia 530 and 630, both labeled “Likelihood of Deal.” In both such UIs, the magnitude of the acceptance rating is represented by a number of highlighted checkmarks (see indicia 540a and 540b, for example), the higher the number of highlighted checkmarks the higher the offer acceptance rating is. It should be appreciated that the example buying recommendations shown in UI 500 have a maximal offer acceptance rating (e.g., five checkmarks out of five total possible checkmarks) because the buyer intends for make a purchase. However, from the seller perspective, at UI 600, offer acceptance ratings have different magnitudes representing the likelihood that a prospective buyer will close a purchase transaction with the seller. With respect to the example UI 500, the recommendation also includes information that characterizes a vehicle (or other type of product depending on the type of recommendation) such as “wholesale listing;” “year make model trim;” “year;” “Kelly Blue Book retail” pricing; “Manheim market report” pricing; “asking price;” percentage of MMR capture in the asking price; percentage of MMR capture by retail price; “odometer;” “color;” “drive, body, engine, fuel, transmission, doors;” “days in stock;” status of membership (e.g., “member”) to a platform that administers or operates the content-based recommendation engine 110; dealership name, city, and state; and distance (“dist. (mi)”) from the dealership (or other type of trading organization) for which the buying recommendations are determined (see indicia 520, for example). In addition, each recommendation also can include a picture (represented with an icon in the shape of a camera) or other media representative or otherwise indicative of the recommended vehicle. Further, in addition to indicia representing the magnitude of the offer acceptance rating (see, e.g., indicia 540a and 540b), a recommendation also can include selectable or actionable indicia 550 that, in response to selection or actuation, can cause a device presenting the UI 500 to initiate an offer or otherwise permit making an offer for the recommended vehicle. For instance, actuation of the indicia 550 can cause the device to present a new window (e.g. a pop-up window) with various fillable fields or other types of indicia related to making an offer for the recommended vehicle. As illustrated, the example UI also includes selectable or actionable indicia 510 that, in response to actuation or selection, can cause the device (e.g., operator device 410) that presents the UI 500 to search for vehicles based on various criteria, such as “certified pre-owned vehicle” (or “certified”), “year,” “make,” “model,” “trim,” “color,” a combination thereof, or the like. One or more of such criteria can be entered in a fillable field included in the indicia 510. In one example, a search query can be entered into the fillable field, and the device can submit the search query to the content-based recommendation platform 110. In response, the device can receive information indicative or otherwise representative of one or more vehicles (or other types of products, depending on the search query).

With respect to example UI 600, the selling recommendations available or otherwise determined for a specific dealer (see, e.g., indicia 610) can include a recommended dealership, shown via indicia 620a and 620b, in the illustrated example selling recommendations. Each of the recommended dealerships, a group of selling recommendations for vehicles available via the recommended dealership. Each of the group of recommendations is ranked or otherwise rated via an offer acceptance rating (“likelihood of deal”), such a ranking shown with respective indicia 640a and 640b, for example. As described herein, each of the recommendations shown in the example UI 600 include information characterizing a recommended vehicle (or other type of product depending on the type of recommendation), such as “year make model trim;” “color;” “VIN;” “stock number;” “days in stock;” name, place of business, and type of the dealership associated with the dealer of recommended vehicles; and distance (“dist. (mi)”) from the dealership for which the selling recommendations are generated or otherwise determined (see, e.g., indicia 610). Further, the example UI 600 also can include selectable or otherwise actionable indicia 650 that, in response to selection or actuation, can cause a device presenting the UI 600 or another device coupled thereto to initiate and/or to send an electronic communication (e.g., an email) to the dealer associated with the recommended vehicle(s). For instance, actuation of the indicia 650 can cause the device to present a new window (e.g. a pop-up window) with various fillable fields or other types of indicia related to transmitting an email or another type of communication (e.g., a text message) to the dealer.

Example Applications of Weighted, Switching and Mixed Hybridization Techniques.

In certain embodiments, the profile learning module 140 and/or the business goal optimization module 150 can support multiple profile types and/or business goal optimization models. Accordingly, in one aspect, the content-based recommendation platform 110 can provide information (e.g., input data, input metadata, and/or instructions) to the recommendation module 120 for any practical combinations of these profiles and models. Examples of such combinations and associated recommendations can include the following: (I) Default Search Result Page. When a user/dealership initially logs into an inventory trading/direct sales website or platform and/or do not request specific search filters, the Search Result Page (SRP) is populated with a default list of vehicles. This list is preferentially generated using Weighted Hybridization, combining all the recommended vehicles identified for every buying profiles vectors of that user/dealership. The ratings from the different recommendation components are combined numerically for each vehicle, resulting in a rated and/or ranked search result page recommended vehicle list.

(II) Personalized Search Result Page. Alternatively or in other embodiments, a user (e.g., car dealership) can be given the capability to select the specific buying profiles (e.g., switching hybridization) to be used for a rated and/or ranked search result page presenting a recommended vehicle list or any other list of recommended products. As such, the search result page is customized (or personalized) to the selected buying profile.

(III) Account Management and Inventory Management Services. In certain embodiments, mixed hybridization can be used to display, simultaneously or otherwise, the recommendations for different combinations of (a) profiles (e.g., buying profile(s) and/or selling profile(s)) and (b) business goal optimization models, thus enabling account management and inventory management services.

(IV) Management of special sale events—e.g., Event Sales and “Ready to Move” sales). In certain implementations, a rated and/or ranked list of recommended vehicles generated in buying mode can be exploited to identify the run list of buyers for every vehicle marked as part of an event sale (e.g., sales occurring at specific predetermined times) of an inventory trading and/or direct sales website. In addition or in other implementations, the rated and/or ranked list of recommended vehicles can be utilized or otherwise leveraged to identify the run list of buyer for every vehicle marked or otherwise identified as being available to be traded under a particular condition (e.g., “ready to move” products). As such, a list of recommended products in accordance with the present disclosure can permit streamlining the reach-out to buyer strategy.

(V) Application to targeted prospecting. In certain implementations, a rated and/or ranked list of recommended vehicles generated in buying mode can be exploited to identify or otherwise determine a prospect list of dealerships that are not a member of an inventory trading website and/or a direct sales website, but have a large ratio of highly rated (or highly ranked) vehicles in their list of recommended vehicles and/or own vehicles that are highly rated (or highly ranked) in the list of recommended vehicles of an inventory trading and/or direct sales website's member. As such, list of recommended products in accordance with the present disclosure can permit thus streamlining the reach-out to prospect strategy. It should be appreciated that while the specific magnitude of high rating (or high rank) can be application and data distribution specific—e.g., 0.7 can be considered to be high in one use case, but average in another use case—, ratings equal to and/or higher than 0.80 can be typically considered as high ratings. It should further be appreciated that, in one example, a streamlined prospect strategy can permit managing or otherwise configuring resources to promote a trading platform associated with a content-based recommendation platform (e.g., platform 110) in accordance with one or more aspects of this disclosure.

Trading recommendations generated with a content-based recommendation platform in accordance with aspects of the disclosure can be utilized or otherwise leveraged for churn management (e.g., retention management) of organization that can trade in a trading platform associated with the organization that administers the content-based recommendation platform. In certain implementations, based on behavioral information (e.g., buying and/or selling behavior information) of an organization, the recommendation module can determine the likelihood of cancellation of the organization's subscription to the trading platform. Moreover, the recommendation platform can generate a trading recommendation directed to minimizing or otherwise reducing the likelihood of a subscription cancellation. In addition or in the alternative, by refining the quality and/or quantity of recommendations provided to the organization, the perceived quality of service of the content-based recommendation platform can increase, with the ensuing reduction of subscription cancellations at the trading platform.

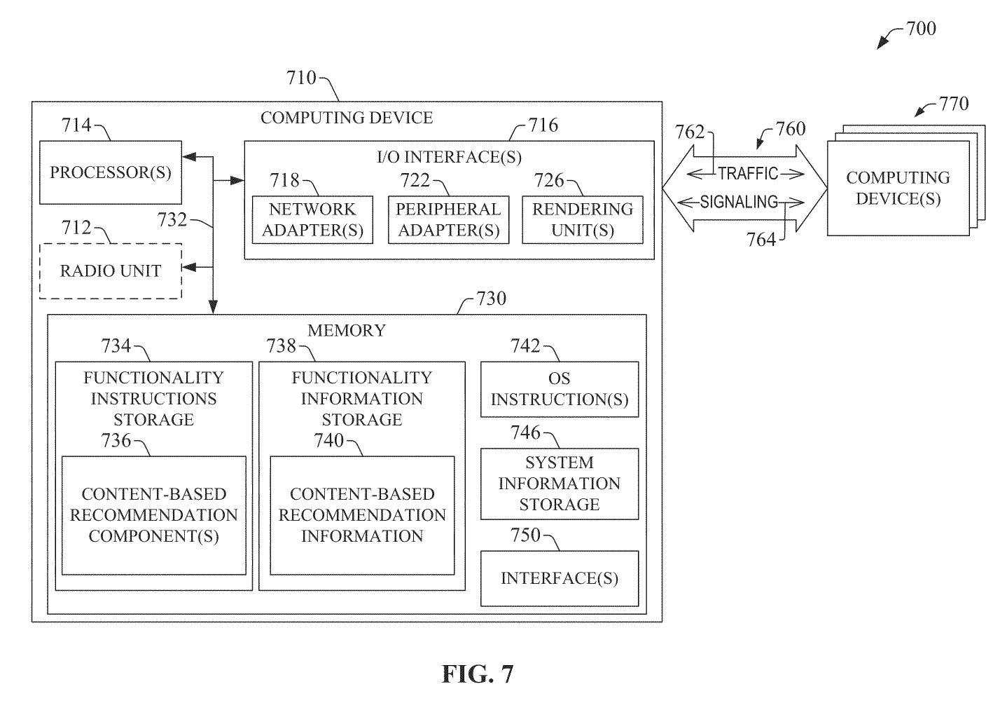

FIG. 7 illustrates a block diagram of an example computational environment 700 for content-based recommendations for organization-to-organization trading of products in accordance with one or more aspects of the disclosure. The example computational environment is merely illustrative and is not intended to suggest or otherwise convey any limitation as to the scope of use or functionality of the computational environment's architecture. In addition, the example computational environment 700 depicted in FIG. 7 should not be interpreted as having any dependency or requirement relating to any one or combination of components illustrated as part of the computational environment 700. As illustrated, the computational environment 700 comprises a computing device 710 which, in various embodiments, can correspond to a computing device (e.g., a server) that can implement at least a portion of the functionality described herein in connection with content-based trading recommendations. At least a portion of the computational environment 700 can embody or can comprise the content-based recommendation platform 110 and one or more components therein shown in FIG. 1.

The computational environment 700 illustrates an example implementation of the various aspects or features of the disclosure in which the processing or execution of operations described in connection with content-based trading recommendations disclosed herein can be performed at least in response to execution of one or more software components at the computing device 710. It should be appreciated that the one or more software components can render the computing device 710, or any other computing device that contains such components, a particular machine for providing content-based trading recommendations as described herein, among other functional purposes. A software component can be embodied in or can comprise one or more computer-accessible instructions, e.g., computer-readable and/or computer-executable instructions. In one scenario, at least a portion of the computer-accessible instructions can embody and/or can be executed to perform at least a part of one or more of the example methods described herein. For instance, to embody one such method, at least a portion of the computer-accessible instructions can be persisted (e.g., stored, made available, or stored and made available) in a computer storage non-transitory medium and executed by a processor. The one or more computer-accessible instructions that embody a software component can be assembled into one or more program modules that can be compiled, linked, and/or executed at the computing device 710 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 710 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the cellular-sharing connectivity service described herein can comprise personal computers; server computers; laptop devices; handheld computing devices, such as mobile tablets and/or telephones; wearable computing devices; and multiprocessor systems. Additional examples can include set-top boxes, programmable consumer electronics, network PCs, minicomputers, mainframe computers, blade computers, programmable logic controllers (PLCs), distributed computing environments that comprise any of the above systems or devices, or the like.

As illustrated, the computing device 710 can comprise one or more processors 714, one or more input/output (I/O) interfaces 716, one or more memory devices 730 (herein referred to generically as memory 730), and a bus architecture 732 (also termed bus 732) that functionally couples various functional elements of the computing device 710. In certain embodiments, the computing device 710 can include, optionally, a radio unit 712. In such embodiments, the computing device 710 can embody or can constitute a consumption device or an injection device that operates wirelessly. The radio unit 712 can include one or more antennas and a communication processing unit (not shown in FIG. 7) that can permit wireless communication between the computing device 710 and another device, such as one of the computing device(s) 770. The bus 732 can include at least one of a system bus, a memory bus, an address bus, or a message bus, and can permit exchange of information (data, metadata, and/or signaling) between the processor(s) 714, the I/O interface(s) 716, and/or the memory 730, or respective functional elements therein. In certain scenarios, the bus 732 in conjunction with one or more internal programming interfaces 750 (also referred to as interface(s) 750) can permit such exchange of information. In scenarios in which processor(s) 714 include multiple processors, the computing device 710 can utilize parallel computing.

The I/O interface(s) 716 can permit communication of information between the computing device and an external device, such as another computing device, e.g., a network element or an end-user device. Such communication can include direct communication or indirect communication, such as exchange of information between the computing device 710 and the external device via a network or elements thereof. As illustrated, the I/O interface(s) 716 can comprise one or more of network adapter(s) 718, peripheral adapter(s) 722, and rendering unit(s) 726. Such adapter(s) can permit or facilitate connectivity between the external device and one or more of the processor(s) 714 or the memory 730. For example, the peripheral adapter(s) 722 can include a group of ports, which can comprise at least one of parallel ports, serial ports, Ethernet ports, V.35 ports, or X.21 ports, wherein parallel ports can comprise one or more of GPIB ports and/or IEEE-1284 ports, while serial ports can include RS-232 ports, V.11 ports, USB ports, or FireWire or IEEE-1394 ports.

In one aspect, at least one of the network adapter(s) 718 can functionally couple the computing device 710 to one or more computing devices 770 via one or more traffic and signaling pipes 760 that can permit or facilitate exchange of traffic 762 and signaling 764 between the computing device 710 and the one or more computing devices 770. Such network coupling provided at least in part by the at least one of the network adapter(s) 718 can be implemented in a wired environment, a wireless environment, or a combination of both. The information that is communicated by the at least one of the network adapter(s) 718 can result from implementation of one or more operations in a method of the disclosure. Such output can include any form of visual representation, including, but not limited to, textual, graphical, animation, audio, tactile, or the like. In certain scenarios, each of the computing device(s) 770 can have substantially the same architecture as the computing device 710. In addition, or in the alternative, the rendering unit(s) 726 can include functional elements (e.g., lights, such as light-emitting diodes; a display, such as a LCD, a plasma monitor, a LED monitor, an electrochromic monitor; combinations thereof; or the like) that can permit control of the operation of the computing device 710, or can permit conveying or revealing the operational conditions of the computing device 710.

In one aspect, the bus 732 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, a Universal Serial Bus (USB), and the like. The bus 732, and all buses described herein, can be implemented over a wired or wireless network connection, and each of the subsystems, including the processor(s) 714, the memory 730 and memory elements therein, and the I/O interface(s) 716 can be contained within one or more remote computing devices 770 at physically separate locations, connected through buses of this form, thereby effectively implementing a fully distributed system. In distributed systems, the content-recommendation component(s) can be distributed amongst the computing device 710 and the remote computing devices 770.

The computing device 710 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 710, and can comprise, for example, both volatile and non-volatile media, and removable and/or non-removable media. In one aspect, the memory 730 can comprise computer-readable media in the form of volatile memory, such as random access memory (RAM), and/or non-volatile memory, such as read-only memory (ROM).

The memory 730 can comprise functionality instructions storage 734 and functionality information storage 738. The functionality instructions storage 734 can comprise computer-accessible instructions that, in response to execution by at least one of the processor(s) 714, can implement one or more of the functionalities of the disclosure. The computer-accessible instructions can embody or can comprise one or more software components illustrated as content-based recommendation component(s) 736. In one scenario, execution of at least one component of the content-based recommendation component(s) 736 can implement at least a portion of the functionality described in the present disclosure, and/or one or more of the methods described herein, such as example methods 1000 and 1100. For instance, such execution can cause a processor that executes the at least one component to carry out a disclosed example method. It should be appreciated that, in one aspect, a processor of the processor(s) 714 that executes at least one of the content-based recommendation component(s) 736 can retrieve information from or retain information in a memory element 740 in the functionality information storage 738 in order to operate in accordance with the functionality programmed or otherwise configured by the content-based recommendation component(s) 736. Such information can include buying profiles, selling profiles, rating models, product recommendations, a combination thereof, or the like. In addition, such information can include at least one of programming code instructions (or code instructions), information structures, or the like. At least one of the one or more interfaces 750 (e.g., application programming interface(s)) can permit or facilitate communication of information between two or more components within the functionality instructions storage 734. The information that is communicated by the at least one interface can result from implementation of one or more operations in a method of the disclosure or any other functionality described herein. In certain embodiments, one or more of the functionality instructions storage 734 and the functionality information storage 738 can be embodied in or can comprise removable/non-removable, and/or volatile/non-volatile computer storage media.

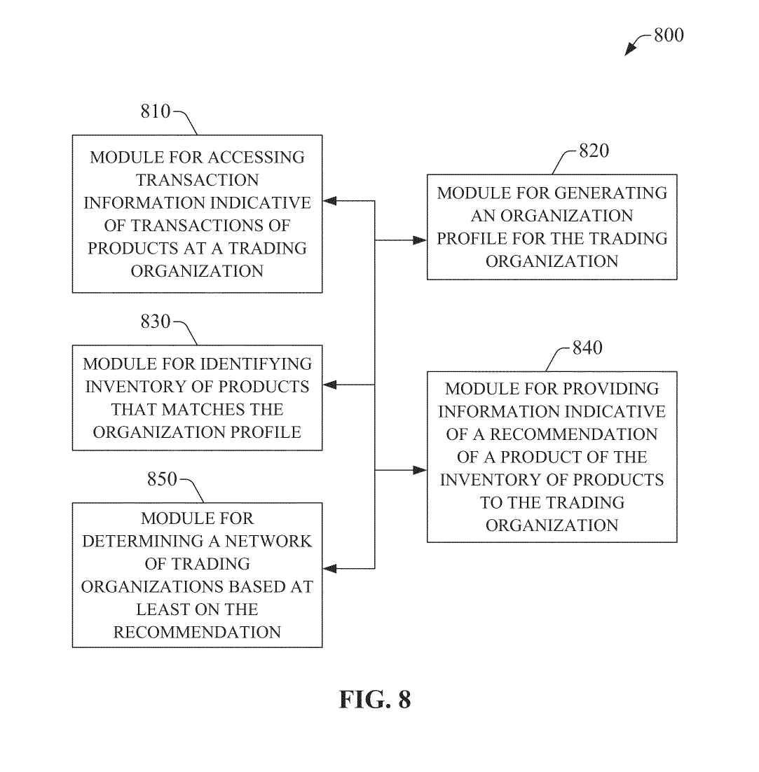

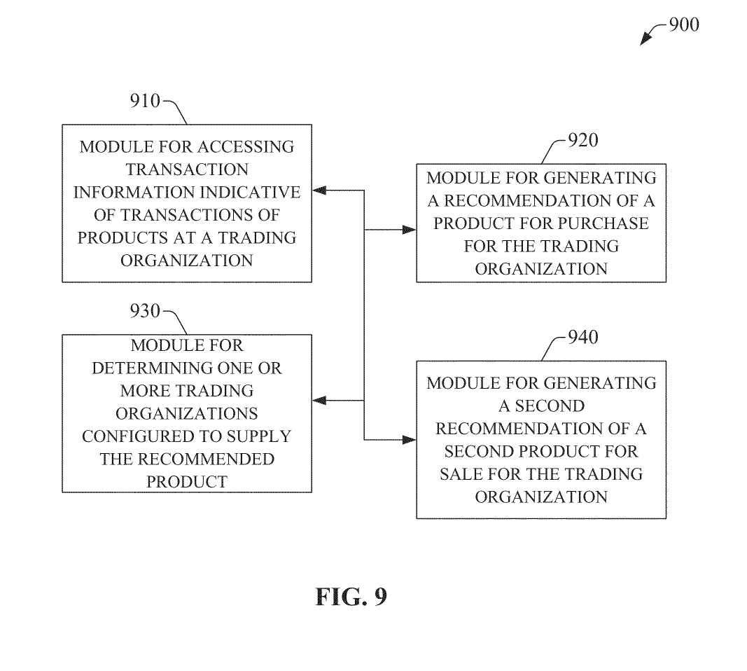

At least a portion of at least one of the content-based recommendation component(s) 736 or content-based recommendation information 740 can program or otherwise configure one or more of the processors 714 to operate at least in accordance with the functionality described in the present disclosure. In one embodiment, the content-based recommendation component(s) 736 contained in the functionality instruction(s) storage 734 can include the profile learning module in content-based recommendation platform 110, the business goal optimization module 150 in the content-based recommendation platform 110 shown in FIG. 1, and/or the recommendation module 120 in the content-based recommendation platform 110. One or more of the processor(s) 714 can execute at least one of the content-based recommendation component(s) 736 and can leverage at least a portion of the information in the functionality information storage 738 in order to provide a trading recommendation in accordance with one or more aspects of the present disclosure. As such, it should be appreciated that in certain embodiments, a combination of the processor(s) 714, the content-based recommendation component(s) 736, and the content-based recommendation information 740 can form means for providing various functionalities of the content-based trading recommendations in accordance with one or more aspects of the disclosure. More specifically, in one example, several combinations can embody an apparatus for content-based trading recommendations in accordance this disclosure, such as the example apparatus 800 shown in FIG. 8. As illustrated, each of such combination can embody or can constitute a module for providing a specific functionality. Therefore, in certain embodiments, the modules can include circuitry (e.g., processing circuitry and/or storage circuitry) and logic to implement the functionality associated with the module in accordance with one or more aspects of this disclosure. As such, the example apparatus 800 can include a module 810 for accessing transaction information indicative or otherwise representative of transactions of products at a trading organization. The example apparatus 800 also includes a module 820 for generating an organization profile for the trading organization. In addition, the example apparatus also includes a module 830 for identifying inventory of products that matches the organization profile, and a module 840 for providing information indicative or otherwise representative of a recommendation of a product of the inventory of products to the trading organization. In certain embodiments, the module 830 for identifying inventory can include a module for determining a trading metric associated with a product on the inventory of products, wherein the trading metric can include a rate of acceptance of an offer (e.g., offer acceptance rating F) to buy the product to the trading organization. Further, the example apparatus 800 also includes a module 850 for determining a network of trading organizations based at least on the recommendation. In another example, other combinations of the processor(s) 714, the content-based recommendation component(s) 736, and the content-based recommendation information 740 can embody another apparatus for content-based trading recommendations in accordance this disclosure, such as the example apparatus 900 shown in FIG. 9. As illustrated, each of such combination can embody or can constitute a module for providing a specific functionality. Therefore, in certain embodiments, the modules can include circuitry (e.g., processing circuitry and/or storage circuitry) and logic to implement the functionality associated with the module in accordance with one or more aspects of this disclosure. The example apparatus 900 can include a module 910 for accessing transaction information indicative of transactions of products at a trading organization. In addition, the example apparatus 900 can include a module 920 for generating a recommendation of a product for purchase for the trading organization, and a module 930 for determining one or more trading organizations configured to supply the recommended product. Further, the example apparatus also can include a module 940 for generating a second recommendation of a second product for sale for the trading organization.

With further reference to FIG. 7, it should be appreciated that, in certain scenarios, the functionality instructions storage 734 can embody or can comprise a computer-readable non-transitory storage medium having computer-accessible instructions that, in response to execution, cause at least one processor (e.g., one or more of processor(s) 714) to perform a group of operations comprising the operations or blocks described in connection with the disclosed methods, and/or other groups of operations associated with the functionality of the present disclosure.

In addition, the memory 730 can comprise computer-accessible instructions and information (e.g., data, metadata, and/or programming code) that permit or otherwise facilitate operation and/or administration (e.g., upgrades, software installation, any other configuration, or the like) of the computing device 710. Accordingly, as illustrated, the memory 730 can comprise a memory element 742 (labeled operating system (OS) instruction(s) 742) that can contain one or more program modules that embody or include one or more operating systems, such as a Windows operating system, Unix, Linux, Symbian, Android, Chromium, or substantially any operating system suitable for mobile computing devices or tethered computing devices. In one aspect, the operational and/or architectural complexity of the computing device 710 can dictate a suitable operating system. The memory 730 also comprises a system information storage 746 having data and/or metadata that permits or facilitates operation and/or administration of the computing device 710. Elements of the OS instruction(s) 742 and the system information storage 746 can be accessible or can be operated on by at least one of the processor(s) 714.

It should be recognized that while the functionality instructions storage 734 and other executable program components, such as the OS instruction(s) 742, are illustrated herein as discrete blocks, such software components can reside at various times in different memory components of the computing device 710, and can be executed by at least one of the processor(s) 714. In certain scenarios, an implementation of the content-based recommendation component(s) 736 can be retained on or transmitted across some form of computer-readable media.

The computing device 710 and/or one of the computing device(s) 770 can include a power supply (not shown), which can power up components or functional elements within such devices. The power supply can be a rechargeable power supply, e.g., a rechargeable battery, and it can include one or more transformers to achieve a power level suitable for operation of the computing device 710 and/or one of the computing device(s) 770, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 718) to connect operationally to the conventional power grid. In another aspect, the power supply can include an energy conversion component, such as a solar panel, to provide additional or alternative power resources or autonomy for the computing device 710 and/or at least one of the computing device(s) 770.

The computing device 710 can operate in a networked environment by utilizing connections to one or more remote computing devices 770. As an illustration, a remote computing device can be a personal computer, a portable computer, a server, a router, a network computer, a peer device or other common network node, and so on. As described herein, connections (physical and/or logical) between the computing device 710 and a computing device of the one or more remote computing devices 770 can be made via one or more traffic and signaling pipes 760, which can comprise wireline link(s) and/or wireless link(s) and several network elements (such as routers or switches, concentrators, servers, and the like) that form a local area network (LAN), a metropolitan area network (MAN), and/or a wide area network (WAN). Such networking environments are conventional and commonplace in dwellings, offices, enterprise-wide computer networks, intranets, local area networks, and wide area networks.

In one or more embodiments, one or more of the disclosed methods can be practiced in distributed computing environments, such as grid-based environments, where tasks can be performed by remote processing devices (computing device(s) 770) that are functionally coupled (e.g., communicatively linked or otherwise coupled) through a network having traffic and signaling pipes and related network elements. In a distributed computing environment, in one aspect, one or more software components (such as program modules) can be located in both a local computing device (e.g. the computing device 710) and at least one remote computing device.

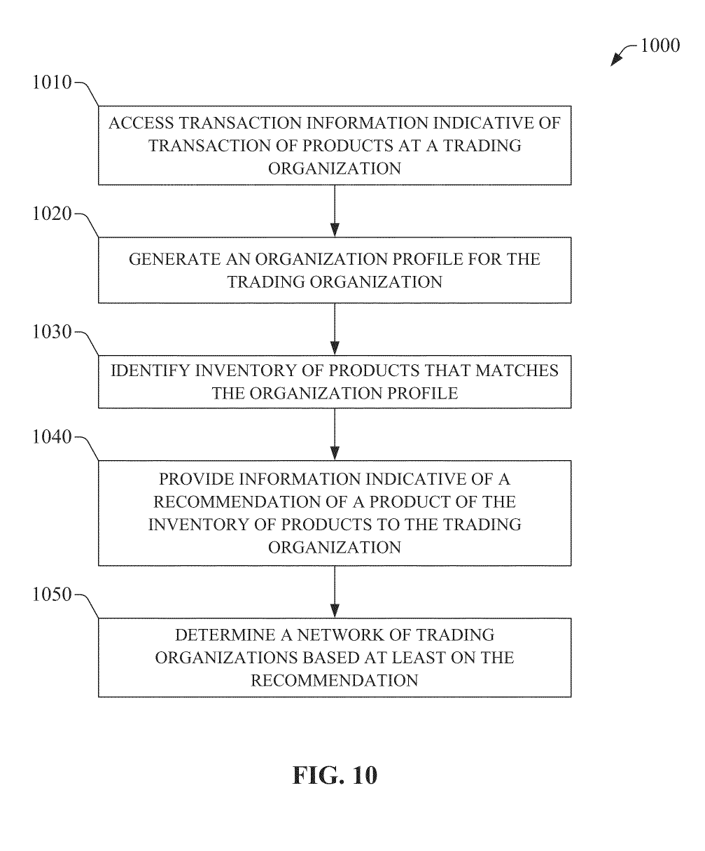

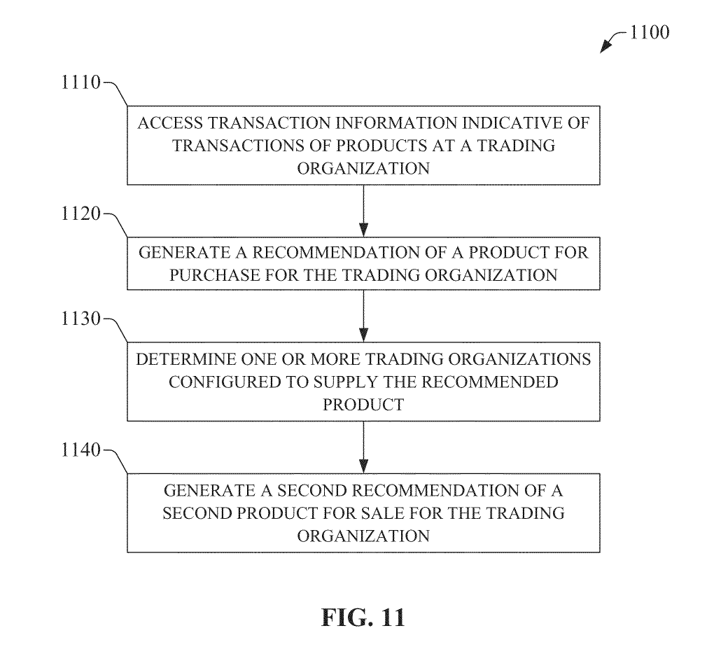

In view of the aspects described herein, example methods that can be implemented in accordance with the present disclosure can be better appreciated with reference to the flowcharts in FIGS. 10-11. For purposes of simplicity of explanation, the example method disclosed herein is presented and described as a series of blocks (with each block representing, for example, an action or an operation in a method). However, it is to be understood and appreciated that the disclosed methods are not limited by the order of blocks and associated actions or operations, as some blocks may occur in different orders and/or concurrently with other blocks from that are shown and described herein. For example, the various methods or processes of the disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

It should be appreciated that the methods of the disclosure can be retained on an article of manufacture, or computer-readable medium, to permit or facilitate transporting and transferring such methods to a computing device (e.g., a desktop computer; a mobile computer, such as a tablet, or a smartphone; a gaming console; a mobile telephone; a blade computer; a programmable logic controller; and the like) for execution and thus, implementation by a processor of the computing device or for storage in a memory device (or memory) thereof or functionally coupled thereto. In one aspect, one or more processors, such as processor(s) that implement (e.g., compile, link, and/or execute) one or more of the disclosed methods, can be employed to execute instructions (e.g., programming instructions) retained in a memory, or any computer- or machine-readable medium, to implement at least one of the one or more methods. The instructions can provide a computer-executable or machine-executable framework to implement the methods disclosed herein.

FIG. 10 presents a flowchart of an example method 1000 for content-based trading recommendations in accordance with one or more embodiments of the disclosure. At least a portion of the subject example method can be implemented (e.g., executed) by a system or computing platform having at least one processor functionally coupled to at least one memory device. Such a system can embody or can comprise a content-based recommendation platform 110 in accordance with aspects described herein. At block 1010, transaction information (e.g., data, metadata, and/or signaling) indicative of transaction of products (e.g., vehicles) at a trading organization (e.g., a buyer car dealership) can be accessed. At block 1020, an organization profile (e.g., a user profile, such as a car dealership profile) for the trading organization can be generated. As described herein, the profile can be an implicit or explicit profile, and can be generated based on rich information (e.g., information retained in information storage 160) that can be accessible to the system of computing platform that implements the subject example method. At block 1030, inventory of products (e.g., a group of vehicles) that matches the organization profile can be identified. As described herein, the recommendation module 120 can identify the inventory of products. At block 1040, information indicative of a recommendation of a product of the inventory of products can be provided or otherwise conveyed (e.g., transmitted or communicated) to the trading organization. To that end, in certain embodiments, the system or computing platform can present user interfaces conveying the recommendation to an operator device (e.g., operator device 410) of the trading organization; see, e.g., UI 500 and UI 600 described herein. At block 1050, a network of organizations can be determined (e.g., extracted) from the recommendation. As described herein, the recommendation module 120 can extract the network of organizations (e.g., dealership network).

FIG. 11 presents a flowchart of an example method 1100 for content-based trading recommendations in accordance with one or more embodiments of the disclosure. At least a portion of the subject example method can be implemented (e.g., executed) by a system having at least one processor functionally coupled to at least one memory device. Such a system or computing platform can embody or can comprise a content-based recommendation platform 110 in accordance with aspects described herein. At block 1110, transaction information indicative of transactions of products at a trading organization can be accessed. To that end, in one example, the system or computing platform can access at least a portion of the information retained in the information storage 160. At block 1120, a recommendation of a product for purchase for the trading organization (e.g., a car dealership; see, e.g., indicia 520) can be generated. As described herein, the system of computing platform can include the recommendation module 120 described herein, which can generate or otherwise determine the recommendation. At block 1130, one or more trading organizations (e.g., car dealership(s)) configured to supply the recommended product can be determined (see, e.g., dealerships associated with a recommendation in UI 500). At block 1140, a second recommendation of a second product for sale for the trading organization can be generated. In one example, the second recommendation conveys a network of one or more second trading organizations (e.g., car dealership(s)) configured to purchase the second product. For example, the example UI 600 in FIG. 6 presents two dealerships, and associated dealers, configured to purchase a vehicle.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and methods (or techniques) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “platform,” “architecture,” “interface,” “unit,” “pipe,” “module,” “source,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that provides, at least in part, the functionality of the electronic components. An interface can include input/output (I/O) components as well as associated processor, application, and/or other programming components. The terms “component,” “environment,” “system,” “platform,” “architecture,” “interface,” “unit,” “pipe,” and “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance the performance of user equipment or other electronic equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, and techniques that can provide content-based recommendations for organization-to-organization trading. As an illustration, a flexible and scalable content-based hybrid recommendation platform and techniques has been described, where such a platform and/or techniques permit generation of a complementary set of dual recommendations for vehicles and dealers networks from a buying and selling perspective. In addition, in certain implementations, the disclosure can leverage or otherwise utilize an optimization module and hybridization techniques to address, in at least certain aspects, various business operational scenarios of an organization (e.g., a car dealership or the administrator of the recommendation platform). It is, of course, not possible to describe every conceivable combination of elements and/or methods for purposes of describing the various features of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A method of recommendations for trading, comprising:
accessing, at a system comprising at least one processor and at least one memory device, transaction information indicative of transactions of products at a trading organization;
generating, at the system, an organization profile for the trading organization, the organization profile representing one of a buying profile or a selling profile;
identifying, at the system, inventory of products that matches the organization profile;
providing, at the system, information indicative of a recommendation for a product of the second inventory of products to the trading organization.

2. The method of claim 1, further comprising determining, at the system, a network of trading organizations based at least on the recommendation.

3. The method of claim 1, wherein the products comprise a vehicle, and wherein the trading organization comprises a car dealership.

4. The method of claim 1, wherein the trading organization comprises a buying organization, and wherein the second trading organization comprises a seller organization.

5. The method of claim 1, wherein identifying the inventory of products that matches the organization profile of the trading organization comprises determining a trading metric associated with a product on the inventory of products.

6. The method of claim 5, wherein the trading metric comprises a rate of acceptance of an offer to buy the product to the trading organization.

7. A method of recommendations for trading, comprising:
generating, at a system comprising at least one processor and at least one memory device, a recommendation of a product for purchase for a trading organization; and
determining, at the system, one or more organizations configured to supply the recommended product.

8. The method of claim 7, further comprising generating a second recommendation of a second product for sale for the trading organization, the second product included in a product inventory of the trading organization, wherein the second recommendation conveys a network of one or more second trading organizations configured to purchase the second product.

9. A system, comprising:
at least one memory device comprising instructions; and
at least one processor functionally coupled to at least one memory device and configured, by the instructions, at least to:
access transaction information indicative of transactions of products at a trading organization;
generate an organization profile for the trading organization, the organization profile representing one of a buying profile or a selling profile;
identify inventory of products that matches the organization profile;
provide information indicative of a recommendation for a product of the second inventory of products to the trading organization.

10. The system of claim 9, wherein the at least one processor is further configured, by the instructions, to determine a network of trading organizations based at least on the recommendation.

11. The system of claim 9, wherein the products comprise a vehicle and the trading organization includes a car dealership.

12. The system of claim 9, wherein the trading organization is a buying organization and the second trading organization is a seller organization.

13. The system of claim 9, wherein the at least one processor is further configured, by the instructions, to determine a trading metric associated with a product on the inventory of products, wherein the trading metric comprises a rate of acceptance of an offer to buy the product to the trading organization.

14. An apparatus, comprising:
means for accessing transaction information indicative of transactions of products at a trading organization;
means for generating an organization profile for the trading organization, the organization profile representing one of a buying profile or a selling profile;
means for identifying inventory of products that matches the organization profile;
means for providing information indicative of a recommendation for a product of the second inventory of products to the trading organization; and
means for determining a network of trading organizations based at least on the recommendation.

15. The apparatus of claim 14, wherein the means for identifying the inventory of products that matches the organization profile of the trading organization comprises means for determining a trading metric associated with a product on the inventory of products.

16. At least one computer-readable non-transitory storage medium having instructions encoded thereon that, in response to execution, cause a computing platform to performs operation comprising:
accessing transaction information indicative of transactions of products at a trading organization;
generating an organization profile for the trading organization, the organization profile representing one of a buying profile or a selling profile;
identifying inventory of products that matches the organization profile;
providing information indicative of a recommendation for a product of the second inventory of products to the trading organization; and
determining a network of trading organizations based at least on the recommendation.

17. The at least one computer-readable non-transitory storage medium of claim 16, wherein the identifying the inventory of products that matches the organization profile of the trading organization comprises determining a trading metric associated with a product on the inventory of products.
